(19) United States
(12) Patent Application Publication
(10) Pub. No.: US 2005/0144118 A1
(43) Pub. Date: Jun. 30, 2005

(54) Method and system for hedging risk of college expenses using options

(76) Inventors: Ashish Kumar Dev, Shaker Heights, OH (US); Yong On Kim, Palisades, NY (US)

Correspondence Address: Mr. Ashish Kumar Dev, 3018 Morley Road, Shaker Heights, OH, 44122, US

(21) Appl. No.: 11/018,123

(22) Filed: Dec. 21, 2004

Related U.S. Application Data
(60) Provisional application No. 60/533,091, filed on Dec. 30, 2003.

(51) Int. Cl. G06F 17/60

(52) U.S. Cl. 705/38; 705/39

(57) ABSTRACT

The present invention addresses uncertainties associated with future college education expenses, and provides a means to resolve these uncertainties. It relates to methods and systems for creating and maintaining an options market for college education expenses. In this system and method, a group of colleges and universities (member institutions) similar in quality and in education expenses form a consortium or contract with an independent third party for an operation of creating an index of member institutions' education expenses and issuing European call options on the index to participating parents who wish to hedge the risk associated with their children's future college education expenses. An index is a weighted average of member institutions' education expenses. A call option here is a pure financial instrument. That is, the option price depends only on the index, not on the likelihood of a child's obtaining admission from one of member institutions. The consortium or the third party plays a role of a broker-dealer and market maker of call options on the index. Participating parents take long positions in call options, while member institutions take short positions in call options. The system provides member institutions a new source of funding.

### REFERENCES

U.S. Patent Documents

| | | |
|---|---|---|
| 20020004782 | January 2002 | Cincotta, David |
| 4,642,768 | February 1987 | Roberts, Peter A. |
| 4,722,055 | January 1988 | Roberts, Peter A. |
| 5,745,885 | April 1998 | Mottola, Anthony J.; et al. |
| 5,809,484 | September 1998 | Mottola, Anthony J.; et al. |

Other References
CollegeBoard “Trends in College Pricing 2004” www.collegeboard.com
Akerlof, G. “The Market for ‘Lemons’: Quality Uncertainty and the Market Mechanism.” Quarterly Journal of Economics 84: 488-500.

### BACKGROUND OF THE INVENTION

1. Field of Invention

The present invention relates to methods and systems for creating and maintaining an options market for college education expenses. In this system, similar-quality colleges and universities (member institutions) whose education expenses vary within a narrow range form a consortium or contract with an independent third party to create an index of member institutions' education expenses, i.e., the weighted average. Through the consortium or the third party, member institutions issue European call options on the index to participating parents who wish to hedge the risk associated with their children's future college education expenses. A call option here is a pure financial instrument. That is, the option price depends only on the index, not on the likelihood of a child's obtaining admission from one of member institutions. The consortium or the third party plays a role of a market maker of call options on the index. Participating parents take long positions in call options, while member institutions take short positions in call options. To member institutions, this is a new source of funding.

2. Description of the Related Art

College education expenses, typically tuition, fee, room and board charged by colleges, have increased so much that most families have to start saving for these expenses early in the child's life. According to the College Board, the average annual cost of a four-year public college has grown to $11,354 for academic year 2004-2005 from $1,936 for academic year 1976-1977, while that of a four-year private college has grown to $27,516 from $3,977 during the same 28-year period. This represents annual percentage increase of 6.5 percent for public colleges and that of 7.2 percent for private colleges during the period between 1976 and 2004. Just to give some idea of what these figures represent, consider a family planning to set aside a fixed amount of money each month for a child's college education and invest this money over a 10-year period. By the time the child is ready to attend a college, i.e., in 10 years, the first-year college expense would be, on average, $21,313 for public college and $55,148 for private college, assuming an annual increase of 6.5 percent for public college and 7.2 percent for private college. Assuming 5% discount rate 10 years from today, at the time the child is admitted to a college, the family would face $87,969 in the present value over the following 4 years of the education expenses for public college and $227,624 for private college, without considering some form of financial aids. How much financial aids would be available depends on the family income and wealth. For example, in academic year 2004-2005, families with family income exceeding $150,000 must assume most of expenses for private colleges except federal tax deduction on interest payments of unsubsidized student loans.

Many financial institutions and state governments offer many savings and investment plans for college education expenses. However, none of these plans addresses uncertainties associated with college education expenses. According to the College Board, annual percentage increase of average college education expense varies widely year by year during the period between 1976 and 2004. During this 28-year period, it varies between 2 to 13 percent for public colleges, and 4 to 13 percent for private colleges. To make matters worse, there is a large variation in dollar amount across different colleges within a same year, more so among private colleges than among public colleges. As families are advised to plan early in the child's life, it is difficult for a parent to plan the amount of savings for their child's college education. This is because a parent cannot assess the child's academic aptitude accurately enough to know which level of colleges the child is likely to attend.

The problem of not knowing which college or university a child will attend can be resolved in a program in which a large group of colleges and universities create a consortium, and through this consortium, issue call options to parents. A parent will choose a call option with an expiration date that coincides with the date a child enters one of consortium colleges. If the average consortium college expense exceeds the strike price of the call option, then the parent will exercise the option. Otherwise, the parent will let the option to expire. This program will work because the consortium include as many colleges and universities as possible so that participants' children will be assured to enroll in one of the consortium colleges. However, by doing this, the variation of education expenses among the consortium colleges will be so large that the program would loose its original intention of using the call options. That is, if a child enrolls in a college whose expense is much higher than the average, then even with the exercise of the call option, the parent would still have to pay the difference. Hence, the option in this case would not help much in terms of reducing the risk of college education expenses. By forming a consortium including only those colleges and universities in a similar quality and in a narrow range of variation of college education expenses, can the above problem be resolved? The answer is “No.” In that case, the market will fail due to the problem of asymmetric information about children's academic aptitude. That is, at the time when parents buy call options, administrators of colleges and universities in the consortium cannot possibly know the children's academic aptitude better than the parents. This is a classic “lemon” problem in economics literature. To see this is the case, consider the following scenario. Suppose that those parents whose children's academic performances are in the top 25% would be interested in enrolling their children in one of the consortium colleges and universities in the future. Those children in the top 1% have a higher probability of being admitted to one of the consortium colleges and universities than those children who have just made in the top 25%, when they reach the age for college. Then, the price of call options will be based on the probability that those children in the middle in the group will be admitted to one of the consortium colleges and universities. In this case, the option is too expensive for parents of children in the bottom half of the top 25%, while it is cheap for those in the top half of the top 25%. Hence, those parents in the bottom half will drop out of the market and the option price will be adjusted upward based on the probability that those children in the middle in the top 12.5% group will be admitted to one of the consortium colleges in the future. This adverse selection process will continue until there is only one parent left who is willing to buy this option at the price that is finally settled. Hence, the market cannot exist under these circumstances.

### SUMMARY OF THE PRESENT INVENTION

The present invention addresses uncertainties associated with future college education expenses, and provides a means to resolve these uncertainties. College education expense for a child is very difficult to predict, not only because percentage increase varies year by year but also because the dollar amount varies widely across different colleges within a same year. In order to have some idea of how much money should be saved for college education for a young child, a parent needs to assess the child's academic aptitude accurately enough to narrow down to which level of colleges the child is likely to attend.

The present invention resolves the above problems that parents face. It proposes a method and system in which a group of colleges and universities (member institutions) similar in quality and in education expenses form a consortium or contract with an independent third party to create an index of member institutions' education expenses and issue European call options on the index to participating parents who wish to hedge the risk associated with their children's future college education expenses. An index is a weighted average of member institutions' education expenses. There can be many different indices associated with many different groups, for example, an index for ivy-league universities, an index for state universities in each state, an index for big ten universities for state residents and that for out-of-state residents, and so on. Some well-known universities may not need to be a part of a group if there are enough interests in those universities among many parents. Those universities can offer call options on their individual education expenses to those interested parents through a third party or directly without a third party.

In this method and system, the price of a call option does not depend on the likelihood of a child's obtaining admission from one of member institutions. That is, call options here are pure financial instruments. Whether or not a child attends one of member institutions, a parent who has bought a call option can exercise the call at the expiration date. Each call option is only for one-year college expense. Hence, those parents who wish to hedge risks for all four years of college expenses will buy four call options with consecutive yearly expiration dates. Since call options here are pure financial instruments and there can be various call options on many indices and on many individual university education expenses, the system and method can resolve another kind of uncertainty for parents who are not sure which group of universities or individual universities their children would attend. In this case, they simply buy options from any combination of groups and individual universities.

The consortium (or the third party) has two administration tasks. First, toward the end of every academic year, it tabulates member institutions' education expenses for the coming academic year and calculates an index, an average of college education expenses weighed by full-time enrollment. The newly calculated index will be announced in a form of newsletter, or in some other form of communication to participating parents. Second, the consortium (or the third party) coordinates in determining what fractional shares of the proceeds from the sale of call options should be assigned to a member institution each year based on each member institution's funding need. For example, if College A is assigned to a 10% share of the group in 2004, then 10% of the proceed of call options issued in 2004 will go to College A. Upon the exercise of call option (issued in 2004) in the future, College A will be responsible for 10% of the option's intrinsic value (the difference between the index and the strike price).

The need for this type of options for college education expenses is quite clear for parents. Colleges and universities also have incentives to offer this type of options. Public colleges depend in large part on state's support on operating expenses. However, during the period of economic downturn, state governments typically lower their supports for public institutions. Private colleges, on the other hand, depend on endowments and tuitions. Often, endowment campaign may prolong and unexpected expenses may arise. Hence, member institutions may like to have this source of temporary funding as a stopgap measure. The outstanding options are temporary liabilities to member institutions until they find a funding source to payoff these liabilities. However, the member institutions can postpone the obligations as far into the future as needed in the following way: Upon the exercise of call options, a member institution can pay the option holders by issuing another round of options that will expire in the future.

The consortium (or the third party) is a broker-dealer of options on college education expenses. Participating parents take long positions in call options, while member institutions take short positions in options. In addition, the consortium (or the third party) plays a role of a market maker of options on college education expenses, as this type of market matures. Suppose that there are a parent who own call options with the 5-year remaining maturity and wishes to sell them and another parent who wishes to buy 5-year call options. In this case, the consortium (or the third party) will simply buy back 5-year options from one parent and sell them to another parent. Since many member institutions likely use option issuance as a temporary funding source, they may be willing to buy back outstanding options before the maturity. Hence, the secondary market for options on college education expenses is likely to emerge much sooner than that for other types of over-the-counter market derivatives.

Unlike other derivatives market, the consortium (or the third party) as a broker-dealer and market maker of options on college education expenses does not bear any risk. That is, there are no inventory risk and no counter-party risk to bear for the consortium (or the third party). If the consortium (or the third party) charges fees to member institutions for the services it provides, then it is unlikely that there would be bid-ask spreads in option prices.

### BRIEF DESCRIPTION OF THE DRAWINGS

FIG. 1 depicts cash flows chart among N member institutions, and M parents. The consortium (or the third party) XYZ sells call options to participating parents on behalf of member institutions. It then distributes the proceeds among member institutions according to fractional shares αᵢ for i=1, . . . , N.

FIG. 2 depicts cash flows chart, showing that the consortium (or the third party) issues 4 call options to a participating parent. Each option is for one-year college expense, characterized by the issuance date T₀, the expiration date Tₜ for t=1,2,3,4, and the strike price Kₜ for t=1,2,3,4.

FIG. 3 depicts information flow chart among the consortium (or the third party), member institutions, and parents. Each year, the consortium (or the third party) XYZ collects information, on education expenses of member institutions (Eᵢ for i=1, . . . , N), calculates the average of education expenses weighed by full-time enrollment (FTᵢ for i=1, . . . , N), and announces the index to participating parents.

### DETAILED DESCRIPTION OF THE INVENTION

A group of colleges and universities (member institutions) similar in quality and in education expenses form a consortium or contract with an independent third party for an operation of creating an index of member institutions' education expenses and issuing European call options on the index to participating parents who wish to hedge the risk associated with their children's future college education expenses. An index is a weighted average of member institutions' education expenses. There can be many different indices associated with many different groups, for example, an index for ivy-league universities, an index for state universities in each state, an index for Big Ten universities, and so on. Some well-known universities may not need to be a part of a group if there are enough interests in those universities among many parents. Those universities can offer call options on their individual education expenses through a third party or directly without a third party.

In this method and system, the price of a call option does not depend on the likelihood of a child's obtaining admission from one of member institutions. That is, call options here are pure financial instruments. Whether a child attends one of member institutions, a parent who has bought a call option can exercise the call at the expiration date. Each call option is only for one-year college expense. Hence, those parents who wish to hedge risks for all four years of college expenses will buy four call options with consecutive yearly expiration dates. Since call options here are pure financial instruments and there can be various call options on many indices and on many individual university education expenses, the system and method can resolve another kind of uncertainty for parents who are not sure which group of universities or individual universities their children would attend. In this case, they simply buy options from a combination of groups and individual universities.

The consortium or the third party coordinates in determining what fractional share (αᵢ for i=1, . . . , N) of the proceeds should be assigned to a member institution each year. For example, if University A is assigned to a 10% share of the proceeds in 2004, then 10% of the proceeds of call options issued in 2004 will go to University A. Upon the exercise of call options issued in 2004 in the future, University A will be responsible for 10% of the option's intrinsic value (the difference between the index and the strike price). Fractional shares αᵢ are based on member institutions' need for funding shortfall this year. Specifically, the consortium or the third party collects projected funding shortfall from each member institution each year. Let FS_{T}_{₀}ⁱ be funding shortfall for i^{th} member institution in year T₀. Then, the total funding need TFS_{T}_{₀} for N member institutions is

$${TFS}_{{T}_{0}} = {\sum }_{i = 1}^{N} {FS}_{{T}_{0}}^{i}$$

Hence, αᵢ is

$${α}_{i} = \frac{{FS}_{{T}_{0}}^{i}}{{TFS}_{{T}_{0}}}$$

If there is no need for the funding through issuing options for a certain member university, then this university requests the consortium or the third party to assign its fractional share zero this year rather than to drop out of the group membership. In this way, the university can retain this source of funding for the possible future use.

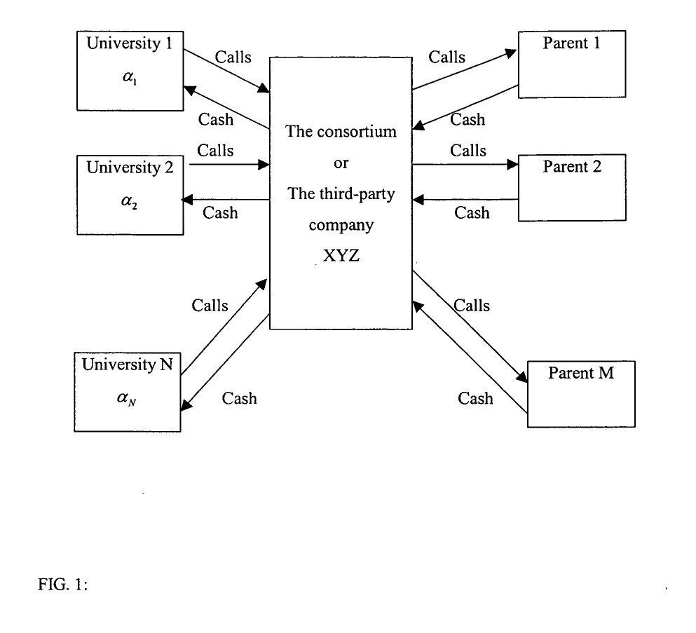

In FIG. 1, the consortium or the third party XYZ plays a role of broker-dealer of options on college education expenses. Participating parents take long positions in call options, while member institutions in the group take short positions in call options. In addition, the consortium or the third party plays a role of a market maker of options on college education expenses, as this type of market matures. For example, suppose that there are a parent who own 5-year options and wishes to sell them and another parent who wishes to buy 5-year options. In this case, the consortium or the third party will simply buy back 5-year options from one parent and sell them to another parent.

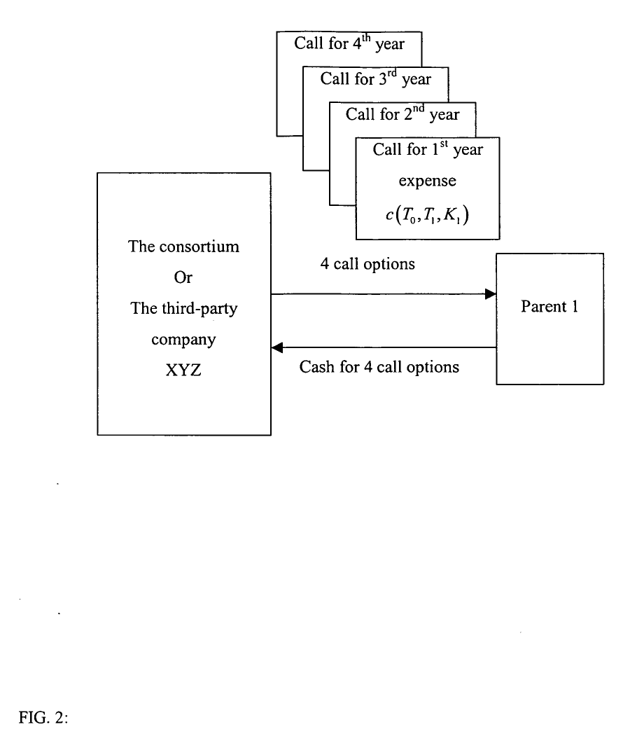

Each call option is only for one-year college expense. Hence, those parents who wish to hedge risks for all four years of college expenses will buy four call options with consecutive yearly expiration dates as depicted in FIG. 2. Specifications of options are the issuance date T₀, the expiration date Tₜ for t=1,2,3,4, and the strike price Kₜ for t=1,2,3,4. The reason why the issuance date should be specified in the option is because at the time of exercise of this option, member institutions are responsible to pay the intrinsic value of the option according to their fractional shares assigned in the year of issuance of the option.

Each year t, the consortium or the third party tabulates member institutions' education expenses for the coming academic year and calculates an index Iₜ, an average of education expenses (Eᵢₜ for i=1, . . . , N) weighed by full-time enrollment (FTᵢₜ for i=1, . . . , N). Specifically, the weight on i^{th} member institution wᵢ is

$${w}_{i} = \frac{{FT}_{it}}{{\sum }_{i = 1}^{N} {FT}_{it}}$$

Hence, the index is

$${I}_{t} = {\sum }_{i = 1}^{N} {w}_{t} {E}_{it}$$

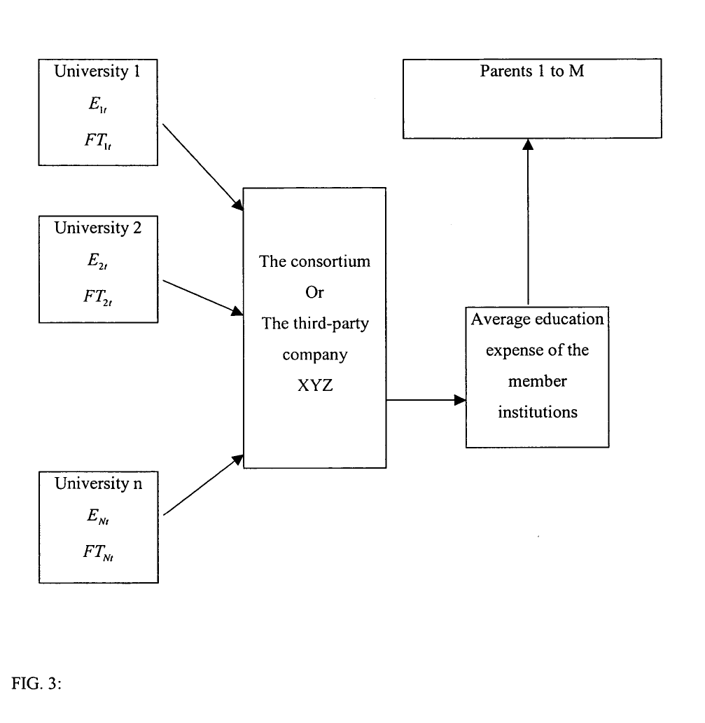

The newly calculated index will be announced in a form of newsletter, or in some other form that can reach a broader segment of parent population. This is depicted in FIG. 3.

At the early stage of this market, the consortium or the third party may need a pricing model to recommend price quotes of options to member institutions. A simplest pricing model is a Black-Scholes formula under an assumption of an index I^{t} following a geometric Brownian motion, i.e.,

$$\frac{{dI}_{t}}{{I}_{t}} = μ dt + σ {dW}_{t}$$

μ is a drift, and σ is a volatility of stochastic component of Iₜ. Wₜ follows a Wiener process such that
dWₜ=ε√\overline{dt}
where ε is a standard normal random variable with a zero mean and a unit standard deviation.

There can be many ways to estimate μ and σ. The choice of methodology depends on the availability of database. There are two well-known databases; one is Annual Survey of Colleges from The College Board, and the other is Integrated Postsecondary Education Data System (IPEDS) from U.S. Department of Education, National Center for Education Statistics. A simplest way to estimate these parameters is to estimate μ as an average percentage annual increase of the index and σ as a percentage volatility of the deviation of the index from the expected index. How many years of data are needed to estimate these parameter values depends on the nature of the member institutions. For example, percentage increase of college education expenses may be more sensitive to the economic cycle for state universities than for well-endowed private colleges. There are many other statistical methods to estimate these parameter variables such as multivariate regression coefficient estimations, maximum likelihood estimations, etc.

Once parameter values are estimated reasonably from the database, the call premium can be obtained as
c(Iₜ,τ)=IₜN(d₁)−Ke^{-rτ}N(d₂)
where

$${d}_{1} = \frac{1}{σ \sqrt{τ}} [ ln ( \frac{{I}_{t}}{K} ) + ( r + \frac{1}{2} {σ}^{2} ) τ ]$$

d₂=d₁−σ√\overline{τ}
τ=T−t
where N(.) is the cumulative normal density function. If the parameter values μ and σ depend on the past parameter value themselves, then the above closed form solution for the call option value cannot be used. In this case, a Monte Carlo simulation or other numerical simulations can be used to calculate the call value.

Because option issuance is a temporary funding source to many member institutions, it is likely that the secondary market for options on college education expenses will emerge soon due to the buyback of outstanding options before the maturity by member institutions. As the market matures and various options are traded frequently, the model prices will become less important than price quotes of options on closely substitutable indices. For example, suppose that Universities A and B are very similar in quality and in education expenses, and both issue call options individually through a third party. In this case, University A cannot insist on getting much higher price quote for call option than University B. If it does, the third party will simply recommend the purchase of call option on University B to a client who wishes to buy call option on University A. This is because a call option on one university is a close substitute for a call option on the other university.

Unlike other derivatives market, the consortium or the third party as a broker-dealer and market maker of options on college education expenses does not bear any risk. That is, there are no inventory risk and no counter-party risk to bear for the consortium or the third party. Hence, if the consortium or the third party charges fees for the services it provides to member institutions, then it is unlikely that there would be bid-ask spreads in option prices.

The above-described arrangement is merely illustrative of the principles of the present invention. Numerous modifications and adaptations thereof will be readily apparent to those skilled in the art without departing from the spirit and scope of the present invention.

1. A system and method for creating and maintaining an options market for college education expenses.

2. The method of claim 1, wherein a group of colleges and universities (member institutions) similar in quality and in education expenses forming a consortium or contracting with an independent third party for an operation of creating an index of member institutions' education expenses and issuing European call options on the index to clients who wish to hedge the risk regarding their children's future college education expenses.

3. The method of claim 2, wherein an index being an average of member institutions' education expenses weighed by full-time enrollments.

4. The method of claim 2, wherein the price of a call option depending only on the index, not on the likelihood of a client's child being admitted to one of member institutions in the future.

5. The method of claim 2, wherein a call option being only for one-year college education expense so that a client who wishes to hedge risks for all four years of college education expenses will buy four call options with consecutive yearly expiration dates.

6. The method of claim 2, wherein the system providing member institutions a new source of funding.

7. The method of claim 2, wherein the consortium or the third party determining the sales proceeds of call options, and assigning and distributing fractional share (αᵢ for i=1, . . . , N) of the proceeds to each member institution each year; inputting projected funding shortfalls or needs for each member institutions each year.

8. The method of claim 7, wherein upon the exercise of call options issued in the past, the consortium or the third party collecting the option's intrinsic value (the difference between the index and the strike price) from member institutions according to the past fractional shares assigned and paying the option holder the intrinsic value.
